(19) United States
(12) Patent Application Publication
(10) Pub. No.: US 2026/0076289 A1
(43) Pub. Date: Mar. 19, 2026

(54) Collecting Device for Determining a Distribution of Agricultural Spreading Material

(71) Applicant: Amazonen-Werke H. Dreyer SE & Co. KG, Hasbergen-Gaste (DE)

(72) Inventors: Justus DREYER, Osnabrück (DE); André GROßE BRINKHAUS, Münster (DE); Per-Christian HEISEL, Osnabrück (DE); Arnd KIELHORN, Osnabrück (DE); Florian RAHE, Lotte (DE); Markus STRÖBEL-FRÖSCHLE, Georgsmarienhütte (DE)

(73) Assignee: Amazonen-Werke H. Dreyer SE & Co. KG, Hasbergen-Gaste (DE)

(21) Appl. No.: 19/110,604

(22) PCT Filed: Jul. 20, 2023
(86) PCT No.: PCT/EP2023/070134

§ 371 Date: Mar. 11, 2025

(30) Foreign Application Priority Data
Sep. 15, 2022 (DE) 102022123600.5

(51) Int. Cl. A01C 7/10; A01C 15/00

(52) U.S. Cl. CPC A01C 7/107; A01C 15/00

(57) ABSTRACT

A collecting device for determining a distribution of agricultural spreading material, comprising a rim element and a receiving element, the rim element comprising a rim portion configured to at least partially delimit the receiving element on at least one side, and the receiving element comprising a collecting portion for collecting agricultural spreading material, and use of at least one such collecting device.

### CROSS REFERENCE TO RELATED APPLICATIONS

The present application claims priority under 35 U.S.C. § 365 to PCT/EP2023/070134 filed on Jul. 20, 2023 and under 35 U.S.C. § 119(a) to German Application No. 10 2022 123 600.5 filed on Sep. 15, 2022, both of which are incorporate by reference in their entireties.

### TECHNICAL FIELD

The disclosure relates to a collecting device for determining the distribution of agricultural spreading material and the use of such a collecting device for determining the distribution of agricultural spreading material.

When agricultural spreading material, in particular fertilizer grains, for example, is being spread, the spreading pattern depends on the flow and flight behavior of the spreading material. This depends on the grain size, grain shape, true density, bulk density and grain strength. It may also depend on other parameters. In principle, there are recommended settings for different spreading materials and different application situations, which can be retrieved from databases or read from so-called spreading tables, taking into account the respective spreading material. However, there may be deviations from the expected spreading pattern, for example, if the quality of the spreading material varies. Consequently, the distribution of agricultural spreading material must be checked in practice. To determine the distribution of agricultural spreading material, it is known to use a collecting device to collect the spreading material and then determine its distribution.

For this purpose, it is known to lay out a collecting device for catching and holding spreading material that has been spread, and to then determine the distribution of the spreading material that has been spread. For example, adhesive mats for this purpose are known from EP 3 576 515 B1 and measuring trays from DE 10 2004 017 075 A1. An example of an application is known from EP 2 923 546 B1.

### SUMMARY

The disclosure is based on the object of providing an improved collecting device. The disclosure comprises a collecting device, as well as a use of such a collecting device.

The collecting device for determining a distribution of agricultural spreading material comprises a rim element and a receiving element.

The rim element comprises a rim portion configured to at least partially delimit the receiving element on at least one side, in particular during use thereof. In particular, the rim portion may be configured to delimit the receiving element on one, two, three, four or more sides, in particular during use of the receiving element.

The receiving element comprises a collecting portion for collecting and optionally retaining agricultural spreading material. In particular, the collecting portion may comprise a plurality of knob-like projections, which are arranged in a grid in the collecting portion. A large number of collecting spaces, in particular a large number of collecting spaces of the same size, may be formed by such projections, in which the grains of the spreading material can be retained at the points where they land on the collecting portion. The knob-like projections may, for example, have the form of rods, tongues, hooks or the like, which extend perpendicular to the surface of the receiving element. Alternatively or in addition, the receiving element may comprise other collecting spaces, for example using other wall boundaries than knob-like projections, e.g. partition walls arranged in a grid or similar. A collecting portion may be configured from a different or the same material as the rest or another part of the receiving element, the two materials typically being firmly bonded to one another. The knob-like projections and/or other wall boundaries, e.g. partition walls, of a receiving element may consist of the same or a different material (or materials) than the rest of the receiving element. In particular, the receiving element may thus comprise one or more materials or be configured from these.

Collecting spaces suitable for a particular spreading material may have a diameter, in particular at the point of smallest diameter parallel to the surface of the receiving element, which is between 2 and 50 times, in particular between 2 and 10 times, the average longest dimension of a spreading material particle or the longest occurring dimension of a spreading material particle To determine the average longest dimension of a spreading material particle, in particular, the longest dimension of several spreading material particles may be measured and an average determined from these. The average longest dimension of a spreading material particle, like the mean size or size distribution, may be known or determined, in particular in order to be able to select a receiving element with a collecting space suitable for the size of the spreading material particles.

The collecting device may be configured for two different application situations. For example, it may be configured for use with different fertilizers, in particular different fertilizer colors and/or different fertilizer grain sizes. Alternatively or additionally, it may be designed for use in different light conditions and/or in crops of different heights and/or in various other situations, for example for different spreading situations with the display of different additional information or for different additional information.

The collecting device may be configured to be flat. The receiving element and/or the rim element may also be configured to be flat.

An object (e.g. the collecting device or the receiving element) being “configured to be flat” may in particular mean that the dimensions of the object in two directions (e.g. length and width), in particular perpendicular directions, are significantly greater than in a third direction (e.g. height), which may in particular be perpendicular to the other two directions. In particular, the dimensions in the two directions may be greater by a factor of at least 3, 4, 10, 20, 30 or 50. The third direction may be the direction in which the object is smallest. When determining the size, recesses and/or holes in the object may be disregarded. Likewise, when determining the size, protruding areas, in particular installation aids, such as stands, legs, in particular if they are fold-out or extendable, may be disregarded; alternatively, such protruding areas, in particular if they are fold-in or extendable, may only be taken into account in the folded-in and/or non-extended state.

The smallest dimension may therefore correspond, for example, to the smallest distance between two imaginary, parallel planes between which the object (optionally without protruding areas or with folded and/or non-extended protruding areas, but optionally including the collecting portion when the receiving element is comprised) could still be pushed. The perpendicular projection of the object on a plane perpendicular to the direction of the smallest dimension of the object may be referred to, in particular, as the “area of the object”.

The “surfaces” of an object may be defined as two opposite upper boundaries of the object, which are typically (essentially) parallel to the surface of the object. The collecting portion may be comprised within these boundaries. Thus, in particular, two surfaces (essentially) parallel to each other and the size of the surface of the object at the distance of the smallest dimension of the object may be considered as surfaces, which are obtained by projecting the object perpendicularly onto two imaginary parallel planes at the distance of the smallest dimension, between which the object (optionally without protruding areas or with folded-in and/or non-extended protruding areas, but including the collecting portion when the receiving element is comprised) may still be pushed.

The collecting portion may be configured to be flat. It may be configured along the surface of the receiving element or along a part of the surface of the receiving element. It may be (substantially) perpendicular to the direction of the smallest dimension of the receiving element, in particular, for example, the direction of its smallest dimension may be (substantially) parallel to the direction of the smallest dimension of the receiving element. The collecting portion, in particular its perpendicular projection onto the plane perpendicular to the direction of the smallest dimension of the object, may extend over a large part, for example at least 50%, for example at least 75%, for example at least 80%, or at least 90%, e.g. 100%, of the surface of the receiving element.

A collecting device may have a height (in the direction of its smallest dimension) of between 0.2 cm and 5 cm, in particular between 0.5 cm and 2.5 cm, in particular between 0.8 cm and 1.2 cm. The width and length of the collecting device (perpendicular to each other and both perpendicular to the height) may each be between 20 cm and 80 cm. In particular, the length may be between 40 cm and 80 cm and the width between 20 cm and 50 cm.

The width and length of the collecting portion (perpendicular to each other and both perpendicular to the direction of the collecting portion with the smallest dimension of the collecting portion and/or collecting device) may in particular each be between 20 cm and 70 cm. In particular, the length may be between 40 cm and 65 cm and the width between 20 cm and 50 cm.

The collecting device may be configured as a single piece, two-piece, or multi-piece.

For example, a collecting device configured as a single piece may comprise a rim element and a receiving element that are configured as a single piece, in particular made of one material, and/or consist of two or more parts that are firmly connected to one another, optionally made of different materials. “Firmly connected” may in particular comprise that two or more elements, e.g. rim element and receiving element, have been manufactured as separate parts, which are connected to each other by fastening means, so that they are no longer detachable from each other without aids (wherein hands do not count as aids) and/or non-destructively. For example, the rim element and receiving element may be firmly connected to one another using an adhesive, a connection using a solvent bond, a mechanical connection such as screws and/or welding.

In a collecting device configured in two or more parts, two or more parts, e.g. rim element and receiving element, may be configured as two or more separate parts that are designed to be in contact with each other during use. Two or more separate parts may, in particular, be in contact with each other during use without connecting means or may be connected to each other by one or more detachable connecting means, in particular in a non-destructive, detachable manner.

The collecting device may comprise two parts made of different materials that are either firmly connected to each other or are non-destructively detachable from each other.

The rim element and receiving element may be configured as two separate parts. A collecting device in which the rim element and receiving element are configured as two separate parts may make it possible to use different materials for the rim element and receiving element, e.g. a softer material for the receiving element than for the rim element.

In the case of a multi-part, e.g. three-part, collecting device, several parts, in particular alternative parts, may be comprised by the collecting device, for example, in the case of a three-part collecting device, a rim element and two receiving elements.

For example, the receiving element and the rim element may be non-destructively detachable from each other and/or connectable to each other. For example, the receiving element and the rim element may be placed on top of each other, hooked into each other or attached to each other by connecting means. In addition to the rim portion configured to at least partially delimit the receiving element on at least one side, the rim element may comprise further portions or structures, for example an opening, recess or net-or grid-like structure, in which the receiving element can be placed, suspended or otherwise attached or inserted.

Alternatively or additionally, a receiving element may comprise a transparent surface, in particular with knobs or compartments, and a replaceable property element may be insertable into the receiving element to change the color, fluorescence or other properties of the receiving element, in particular for different application situations.

The rim element and the receiving element may comprise mutually matching connecting means by which they can be connected to one another. For example, the rim element may comprise hooks, hook-and-loop fasteners, eyelets, openings, tabs or the like, which can be connected to corresponding complementary pieces on the receiving element, e.g. eyelets, hook-and-loop fasteners, hooks, tabs or the like. The receiving element and the rim element may be connectable to each other by connecting means, for example, in a form-fit manner, force-fit manner, by hook-and-loop fasteners and/or other connecting means. They may be connectable to each other in such a way that they cannot be moved relative to each other in at least one, e.g. at least two, three, four or more directions when connected. “Non-destructively detachable” may in particular comprise that the rim element and the receiving element can be separated from each other non-destructively and optionally without further aids (wherein hands do not count as aids).

The rim element may be configured, for example in the form of a mat or a flat rectangular cuboid, with a rim portion and a center portion. The center portion may be configured to receive the receiving element, that is, in particular, configured such that the receiving element may be inserted. For example, it may have the same shape as the surface of the receiving element, but be larger by more than 1%, in particular more than 2%. The center portion may be configured as a recess in the rim element that is open on one side of the rim element. For example, a rim element, in particular, e.g., a mat or a flat rectangular cuboid, may be configured to be thinner in the center portion than in the rim portion or to be interrupted in the center portion, e.g., comprise an opening.

In some examples, the center portion may comprise a lattice-or screen-like structure or the like instead of the recess into which the receiving element may be inserted. Optionally, for example, the receiving element may comprise counterstructures matching the lattice-like structure, e.g., recesses into which the lattice-like structure can engage or be inserted.

The collecting device may comprise two collecting portions. The collecting portions may be arranged next to each other, in particular as partial surfaces (e.g. of the same size or different sizes) arranged next to each other or in the vicinity of each other on a receiving element, and/or along surfaces, in particular opposite surfaces, of the receiving element. Alternatively, two collecting portions may be comprised by different receiving elements.

The two collecting portions may comprise different properties. For example, they may comprise different colors (e.g. complementary colors) or different brightnesses (e.g. black and white) and/or be configured for different grain sizes. Configured for different grain sizes may, in particular, comprise knob-like projections at different distances, resulting in collecting spaces of different sizes on the different collecting portions, or otherwise the size of the collecting spaces in the different collecting portions being different.

The receiving element may, for example, be configured to be turnable. “Turnable” may, in particular, comprise two opposite surfaces, each comprising a collecting portion, wherein the collecting portions comprised on the opposite surfaces may, in particular, comprise different properties. Thus, in particular in the case of a collecting device configured in one piece, the collecting device as a whole may be turned over in order to be able to use a collecting portion with a different property. In the case of a receiving device, where the receiving element and the rim element are separate parts, a turnable receiving element may be turned over when it is not connected to the rim element or inserted therein. It may then be placed into a rim element lying on the ground with the collecting portion selected for use facing upwards.

In other examples, in particular three-part examples, of collecting devices, the receiving element may be exchangeable so that with different receiving elements of the collecting device, the collecting device is suitable for different application situations.

The collecting device, in particular a rim portion, a collecting portion and/or the two (or more) collecting portions, may optionally comprise one or more additional information items and/or a receptacle for additional information, and in particular be configured for two different application situations.

Such additional information may, for example, comprise a marking. A marking may, in particular, comprise a color marking, a pattern, a QR code, color coding and/or another form of optical labeling. It may, for example, allow detection of which collecting device, e.g. which rim portion and/or which collecting portion(s) are currently visible, in particular, can currently be used. The additional information or receptacle for additional information may also comprise information about the color of the collecting device or a part thereof. This information about the color of the collecting device or a part thereof can then be used, for example, to match the expected color.

Additional information may be comprised on the receiving element or receiving elements, in particular on the collecting portion or collecting portions, in order to distinguish these from one another. If a collecting portion comprises knob-like structures, for example, one or more additional information items may be comprised as recesses in the knob-like structures, as a marking on the knob-like structures. Alternatively or additionally, additional information may be comprised in the rim element, e.g. in the form of a marking.

A receiving element for additional information may be comprised in the rim element and/or receiving element. It may be designed to include or comprise, in particular, a display, e.g. for indicating a QR code, serial number for tests, installation position, in particular GPS position, and/or other writing, as one or more lamps, in particular LED lamps, or as a receptacle or recess for a marking, e.g. color plates, QR codes or writing.

The collecting device may be configured for use in tall crops. In this context, “tall crops” may comprise, in particular, crops (e.g. in a field) that are taller than 5 cm, for example taller than 10 cm, for example taller than 20 cm, in particular taller than 50 cm. In this case, the height specification always refers to the average height of the crops in the field or in a portion of the field, in particular the portion in which determining the distribution of the agricultural spreading material is to be carried out.

The collecting device may be configured in such a way that it comprises one or more installation aids, in particular on the rim element and/or receiving element. Such an installation aid may comprise one or more stands and/or fold-out and/or extendable standing aids or be configured as such.

A stand may, for example, comprise or be configured as one, two or more fixed legs or comprise or be configured as an extendable stand, which is extendable, for example, like the stand of an ironing board, in that two legs are connected to each other via a centrally arranged joint, one of the legs is connected to the underside of the collecting device via a fixed joint and the other leg is connected to the underside of the collecting device via a movable joint, wherein the movable joint is configured such that it can be displaced parallel to the underside of the collecting device. Fold-out standing aids may comprise a plurality of standing aids, e.g. two, four or more.

For example, two fold-out standing aids may be configured like the legs of a beer table, i.e. comprise two fold-out legs that can be fastened in a position parallel to the collecting device and, after loosening the fastening and moving the legs into a folded-out position, can be fastened in this position, in particular perpendicular to the collecting device.

Alternatively or additionally, fold-out standing aids may comprise, for example, four or more fold-out legs which, in the folded-in position, lie along the rim element and/or the receiving element and, in the folded-out position, may enclose an angle, for example of about 90°, with the surface of the receiving element, for example between 45° and 135° or between 75° and 105°. Extendable standing aids may, in particular, be extendable like a telescope, for example, and optionally configured such that they can be brought to different lengths, e.g. two, three or more lengths, and can be fixed at these lengths, i.e. are sufficiently stable at these lengths to stabilize the collecting device during use. For example, extendable standing aids may optionally also be fold-out, i.e. extendable and retractable like a telescope.

Extendable stands and/or fold-out and/or extendable standing aids may, for example, be arranged in such a way that the collecting device can be used with the stand extended and not extended and/or the standing aids folded out and folded in and/or extended and folded in, i.e. in particular in different situations. Typically, the installation aids are configured or can be extended or folded out to a length such that they can be placed on the surface of the field through the crops and/or are long enough to be stabilized by the crops (even without being in contact with the surface of the field).

The collecting device may comprise an indicator for horizontal alignment of the collecting device, which may be particularly suitable for horizontal alignment of the collecting device in tall crops. The indicator may be arranged in the rim portion and/or receiving portion. It may, for example, be configured as a spirit level indicator, in particular as a round spirit level or two elongated spirit levels that are optionally perpendicular to one another, as an electronic indicator and/or similar.

The collecting device may have a large contact area at a low weight, so that it is configured in particular for use in tall crops. In particular, the collecting device may have a weight per unit area of less than 50 kg/m², e.g. less than 25 kg/m², e.g. less than 10 kg/m², in particular less than 5 kg/m², e.g. less than 1 kg/m².

The collecting device, in particular the rim element and/or the receiving element, may comprise a device for influencing the light conditions, in particular the light conditions when photographing the collecting device. Using a device for influencing the light conditions, the collecting device may be configured in particular for two different application situations, e.g. in more or less light.

For example, the device for influencing the lighting conditions may comprise a light, which may be configured in particular to illuminate at least part of the receiving element, e.g. at least part of the collecting portion, in particular the entire collecting portion. Thus, the illumination may allow the collecting device to be used even in unfavorable lighting conditions.

Such illumination may, for example, comprise one or more LEDs, LED ribbons, LED strips and/or other lamps. The illumination may be controllable so that its brightness can be adjusted. For example, it may be adjustable in determined steps or continuously. For example, the lighting may be controlled by one or more switches or buttons on the collecting device or may be wirelessly controllable via a wireless connection, e.g. via Bluetooth, Wifi or another connection. This may, for example, enable control via a mobile device, e.g. a smartphone. In particular, the lighting may be controllable in such a way that only parts of the lighting are controlled individually. Alternatively or in addition, the lighting may be controlled by an internal control loop in the collecting device, e.g. depending on a detected ambient lighting. For this purpose, the collecting device may comprise, for example, a brightness sensor or light sensor. By controlling the lighting, in particular a controller, so that the lighting conditions meet predetermined conditions when taking pictures, comparable lighting conditions may be generated in particular when several pictures are taken.

The lighting may comprise lighting on at least one side of the collecting device.

For example, illumination on at least one side of the collecting device may comprise illumination on at least one side of the rim element and/or the receiving element.

“Illumination on at least one side of an object”, e.g. the collecting device, the rim element and/or the receiving element, may in particular comprise or mean that an illumination is arranged away from the center of gravity of the surface of the object. For example, one or more point-shaped, line-shaped or other illumination(s) along an imaginary, in particular straight, line or another geometric figure, e.g. a semicircle or circular arc, on at least one side of the object may be comprised.

In particular, illumination on at least one side of an object may comprise illumination being arranged and/or controllable on one side, in particular in the form of a point or along a straight line, and in particular only on one side, in particular arranged and/or controllable in the form of a point or along a straight line. Thus, for example, by switching on the lighting, the spreading material lying on the collecting device may be illuminated from one side and the harsh shadows may be recorded by a camera. The harsh shadows, optionally together with further information about the collecting device, such as the area, dimensions or active area of the collecting portion, i.e. the area of the collecting portion in which spreading material is collected, may thus enable an evaluation of the spreading pattern of the spreading material. In particular, the grain sizes, in particular a grain size distribution, can be determined from the harsh shadows, in particular if further information about the collecting device, e.g. the dimensions, is known.

The collecting device may comprise illumination around the collecting portion of a receiving element. In particular, the illumination may be comprised on several sides of the collecting portion, in particular in a linear or curved manner, e.g. circularly, around the collecting portion of the receiving element. For example, in the case of a rectangular surface of the receiving element, in particular of the collecting portion, the illumination may be arranged on two, three or in particular four sides of the receiving element, in particular of the collecting portion, in particular on the receiving element and/or the rim portion of the rim element. Such a distribution of the illumination, in particular around the collecting portion of the receiving element, may allow the most uniform illumination possible of the collecting portion.

The collecting device may be configured to be fluorescent and/or reflective in at least one portion and/or comprise a flat illuminant, e.g. an LED or OLED panel. For example, a collecting portion may be configured to be fluorescent and/or reflective, which, when taking a picture, e.g. using a camera with a flash, can lead to good illumination of the picture and/or to the spreading material located on the collecting portion being recognizable as dark areas in the picture. With a flat illuminant, which may be comprised in particular along the collecting portion, the spreading material located on the collecting portion may likewise be recognizable as a dark area in the picture, in particular independently of darkening. A flat illuminant, like a fluorescent collecting portion, may comprise a certain color or a certain color range, which may in particular enable good detectability of spreading material of certain colors, in particular, for example, of the complementary color.

A collecting device that is configured to be fluorescent and/or reflective and/or comprises a flat illuminant may also make it easier to detect interfering objects, such as contaminants.

The collecting device may also comprise one or more solar cells for supplying energy to the device for influencing the light conditions. Alternatively or additionally, one or more batteries, in particular secondary batteries, may be provided for supplying energy. Alternatively or additionally, a connection for an external power source would also be possible.

The disclosure further comprises a use of a collecting device as described above for determining a distribution of agricultural spreading material.

The use may comprise a step of selecting the desired collecting portion, for example in the case of a turnable embodiment of the collecting portion and/or three or multi-part embodiments of the collecting device. Optionally, the use may further comprise attaching the receiving element with the collecting portion to the rim element so that the desired collecting portion is oriented upwardly for use. Optionally, this may be preceded by a step of removing an existing receiving element and/or turning a receiving element.

Such use may comprise laying out a collecting device. Laying out the collecting device may in particular comprise deploying the collecting device in high crops, e.g. by laying it out horizontally using an indicator for horizontally aligning the collecting device.

Optionally, one or more stands and/or standing aids may be used, in particular, for example, folded out and/or extended, in particular, extended to the correct length.

Subsequently, agricultural spreading material may be spread on the collecting device, for example when crossing the field.

The use may comprise controlling a lighting system for the collecting device, for example using a mobile device, e.g. a cell phone. Alternatively, the use may comprise an automatic control of the lighting based on (measured) light conditions, e.g. with a (brightness) sensor included in the collecting device or a mobile device.

The use may alternatively or additionally include taking a picture of the collecting device on which agricultural spreading material has been spread and determining a distribution of agricultural spreading material from this. When taking the picture of the collecting device, one or more additional information, e.g. markings, of the collecting device may be used for positioning the camera and/or for evaluating the picture. The use may alternatively or additionally comprise removing the agricultural spreading material from the collecting device, in particular the receiving element, and collecting it, e.g. in a funnel, and measuring it volumetrically or by weight in order to determine a distribution of agricultural spreading material therefrom.

### BRIEF DESCRIPTION OF THE DRAWINGS

Further details and aspects of the disclosure are described in the following (not to-scale) figures.

FIGS. 1a and 1b show an exemplary collecting device;

FIGS. 2a-2f show exemplary rim and receiving elements;

FIGS. 3a-3c show collecting devices and receiving elements with additional information;

FIGS. 4a and 4b show an exemplary collecting device for use in tall crops;

FIG. 5 shows a collecting device with a device for influencing the light conditions.

### DETAILED DESCRIPTION

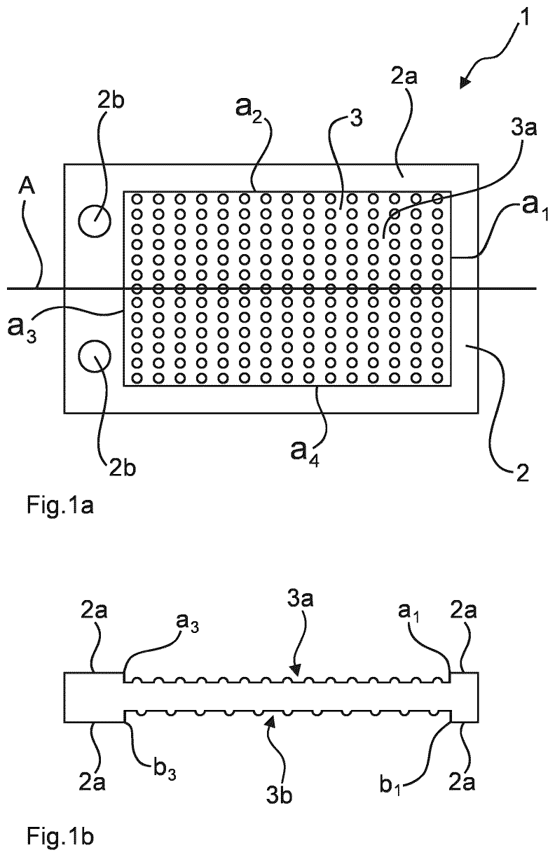

FIG. 1a shows a top view of an exemplary collecting device 1. The collecting device comprises a rim element 2 and a receiving element 3. In the example shown, the collecting portion exemplarily extends over the entire surface of the receiving element 3.

In the example shown, the collecting device is configured as a single piece, in particular made of a single material. In other examples (not shown here), the collecting device may in particular be configured in one piece from two or more than two parts that are firmly connected to one another; for example, the receiving element 3, in particular e.g. collecting portion 3a (and/or one or more further collecting portions, e.g. a collecting portion 3b optionally arranged on the rear) may be made from a different, in particular softer, material than the rim element 2, in particular the rim portion 2a of the rim element 2.

Rim portion 2a is configured to delimit receiving element 3 on at least one side, in FIG. 1a in particular exemplarily on four sides, which may be configured for example as a virtual connection of lines a1, a2, a3, a4 (and optionally on the rear side for example as a virtual connection of lines b1, b2, b3, b4). The sides of the receiving element 3 may, as in this example, coincide with the sides of the collecting portion 3a, but need not do so.

Also drawn are optionally present openings 2b, which, for example, may facilitate or enable transport, e.g. lifting, and/or storage, e.g. hanging, of the collecting device. In other examples (not shown), the collecting device may also comprise none, one or more than two openings 2b.

FIG. 1b shows a cross-section through line A of the collecting device 1 of FIG. 1a. Shown are exemplary rim portions 2a of the rim element on two opposite sides of the collecting device 1, as well as collecting portions 3a and 3b of the receiving element 3. In the example shown, the receiving element 3 comprises two collecting portions 3a, 3b, which are arranged on opposite sides of the receiving element 3. The receiving element 3 is thus configured to be turnable. The two collecting portions 3a, 3b may have different properties. In particular, as in this example, they may comprise collecting spaces of different sizes and may thus be configured in particular for receiving spreading material of different sizes.

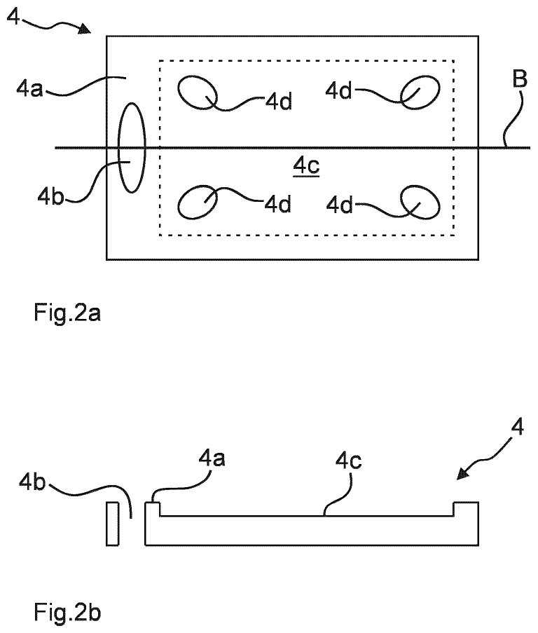

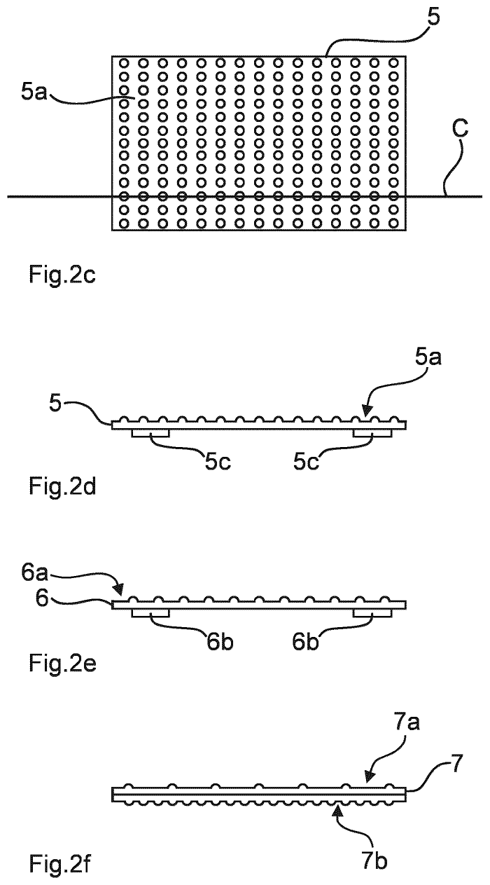

FIG. 2a shows an exemplary rim element 4 comprising a rim portion 4a, an optional opening 4b, a center portion 4c with optional connecting means 4d.

The center portion 4c is configured here in the form of a recess in the rim element. Four connecting means 4d are shown here as an example, each of which is arranged remote from the center of the surface of the center portion 4c in the direction of the four corners of the center portion 4c. The connecting means 4d may be suitable for establishing a connection with a receiving element by gluing, magnetic connection, insertion, form fit, clipping, or other connection options. For example, the connecting means 4d may be configured as one half of a hook-and-loop fastener. In other embodiments, more or fewer than four connecting means may optionally be arranged at other locations of the center portion 4c.

FIG. 2b shows a section through rim element 4 from FIG. 2a along line B with rim portion 4a, optional opening 4b and center portion 4c in the form of a recess into which a receiving element can be inserted.

FIG. 2c shows a schematic top view of an exemplary receiving element 5. In this example, the receiving element 5 comprises a collecting portion 5a having a plurality of collecting spaces, wherein the collecting portion may optionally be arranged over the entire surface of the receiving element. The receiving element 5 is configured to be used together with a rim element, in particular rim element 4, for example to be inserted into a center portion, in particular a recess, as shown in FIGS. 2a and 2b. In the inserted state, the receiving element is delimited on the four sides by the rim element 4 in the example shown.

FIG. 2d shows a cross-section through receiving element 5 with a collecting portion 5a with, in particular, equally sized collecting spaces, wherein the collecting portion may optionally be arranged along the entire surface of the receiving element, and fastening means 5c, which may in particular be configured as complementary pieces to fastening means 4d.

FIG. 2e shows a cross-section through a further receiving element 6 with a collecting portion 6a with collecting spaces, in particular of equal size, and fastening means 6c, which may in particular be configured as complementary pieces to fastening means 4d.

The receiving elements shown in FIGS. 2d and 2e may differ in their properties, e.g. material, color or the like, so that they may be configured for different application situations. In particular, they may differ in the size of their collecting spaces, so that they may be configured for spreading material of different sizes, in particular for two different application situations.

Two different receiving elements, e.g. as shown in FIGS. 2d and 2e, may be comprised in a collecting device, in particular may be interchangeable. The collecting device may further comprise a rim element, e.g. as shown in FIG. 2a, so that the three-or multi-part collecting device may be configured for two different application situations.

FIG. 2f shows an exemplary turnable receiving element 7 with collecting portions 7a and 7b. The collecting spaces shown in collecting portions 7a and 7b differ in their properties, in particular in their size, so that the receiving element 7 is configured for different application situations. The receiving element 7 is configured to be used together with a rim element, in particular rim element 4 from FIG. 2a. It may, for example, be inserted into a center portion, in particular into a recess as shown in FIGS. 2a, 2b. Depending on the application situation, it may be inserted in a turnable manner with collecting portions 7a or 7b oriented towards the center portion of the rim element, so that collecting spaces of the collecting portions 7b or 7a are available for the application. The collecting portions with the collecting spaces may optionally be arranged on the entire surface of the receiving element, or alternatively only on a portion of the surface of the receiving element (not shown).

In other embodiments (not shown here), the two opposite sides of a receiving element may comprise different properties other than the size of the collecting spaces, e.g. different colors, materials or the like.

An exemplary device may, for example, be designed in two or more parts and comprise a rim element 4 together with a turnable receiving element 7, and thus be configured for two different application situations.

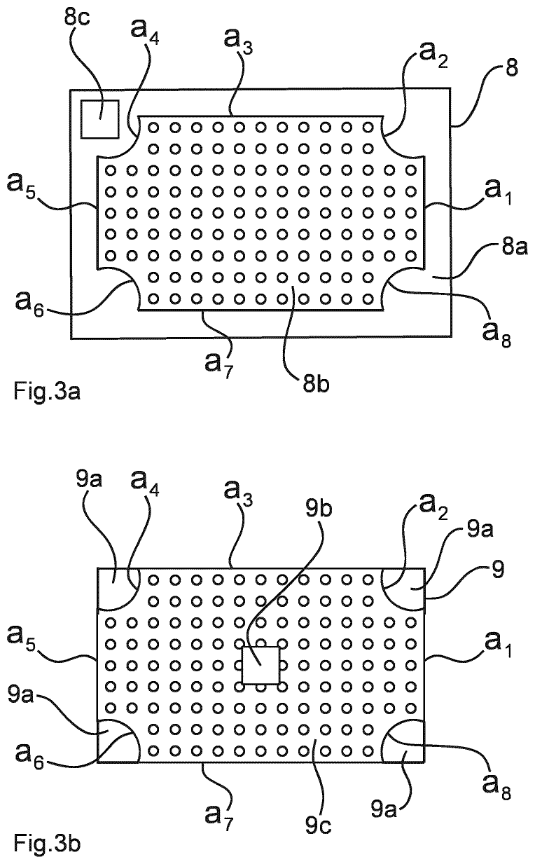

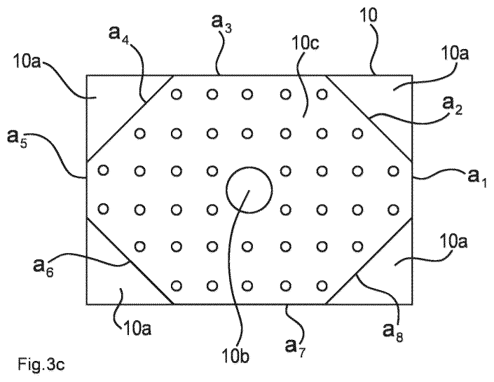

FIG. 3a shows a collecting device 8 with a receiving element comprising a collecting portion 8b and a rim element 8a. The collecting device 8 may, for example, be configured in one or two parts.

The collecting device comprises, for example, additional information, which may be comprised, for example, in the shape and length of the lateral boundaries a1-a8 of the collecting portion 8b. In this case, the lateral sides that delimit the receiving element may run through the lines drawn in the figures as a1-a8, in particular perpendicular to the surface of the collecting device. The collecting portion 8b may therefore be delimited laterally by the rim region of the rim element 8a from a1 to a8.

The collecting device further comprises an optional receptacle for additional information 8c, which is arranged exemplarily in the rim portion 8a of the rim element. In other examples (not shown here), such an optional receptacle for additional information may also be arranged in the receiving element.

FIG. 3b shows an exemplary receiving element 9 that can be inserted into a rim element, for example as shown in FIG. 2a, or that can be firmly connected to a rim element, for example a rim element as shown in FIG. 2a.

The receiving element 9 comprises additional information, which may, for example, be comprised in the shape and length of the lateral boundaries a1-a8 of the collecting portion 9c, the resulting recesses in the collecting spaces of the receiving element 9a and/or the shape and position of an optional receptacle for additional information 9b. Receiving elements with different properties may each comprise different additional information. Thus, for example, the additional information can be used to identify the properties of the receiving element, e.g. the size of the collecting spaces, the color and/or other properties, and thus enable a targeted selection of the receiving element for use and/or enable a targeted selection of a receiving and/or evaluation algorithm.

FIG. 3c shows a collecting device 10 configured, for example, as a single piece, wherein a rim element having rim portions 10a delimits the receiving element 10c on at least one side, here in particular the sides corresponding to the boundaries a2, a4, a6 and a8. The collecting device 10 may comprise additional information 10b, which may be comprised, for example, in the shape and length of the lateral boundaries a1-a8 of the receiving element 10c, the shape of the rim portion 10a and/or the shape and position of an optional receptacle for additional information 10b. The collecting device 10 may optionally comprise two fixedly connected parts made of different materials, wherein, for example, the collecting portion 10c of the receiving element may be configured from a softer material than the rim element with rim portions 10a.

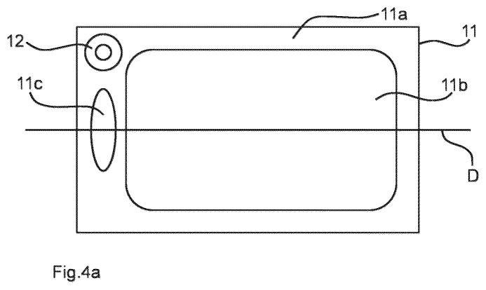

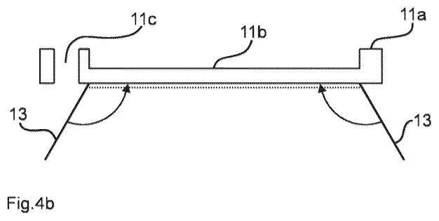

FIG. 4a shows an exemplary rim element 11 of a collecting device for use in tall crops. The rim element 11 comprises a rim portion 11a and a receiving element recess 11b. Optionally, the recess may comprise a receiving element that may optionally be fixedly or loosely connected to the rim element (not shown).

The rim element may comprise an optional opening 11c. It comprises an indicator 12 for horizontal alignment of the collecting device, which here exemplarily comprises a round spirit level.

FIG. 4b shows a cross-section through line D in FIG. 4a with rim portion 11a, recess 11b and optional opening 11c. The rim element 11 comprises installation aids 13, which in this case in particular comprise two fold-out standing aids. With this stand, the collecting device may be used in high crops.

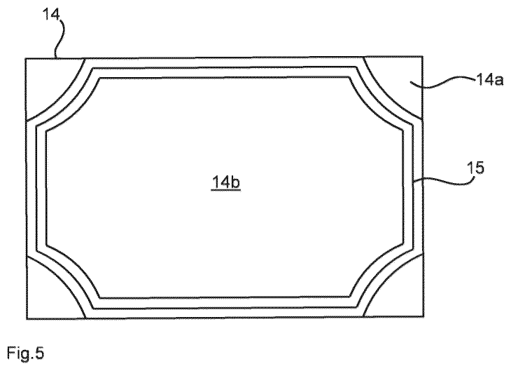

FIG. 5 shows a collecting device 14 with a rim element with rim portion 14a and a receiving element with collecting portion 14b. The collecting device comprises a device for influencing the lighting conditions, which in particular here comprises an illumination 15. Illumination 15 is arranged, in particular linearly, around the collecting portion 14b of the receiving element. This distribution of the illumination 15 around the collecting portion allows the most uniform illumination possible of the collecting portion.

1. A collecting device for determining a distribution of agricultural spreading material, comprising a rim element and a receiving element, wherein the rim element comprises a rim portion configured to at least partially delimit the receiving element on at least one side and the receiving element comprises a collecting portion for collecting agricultural spreading material, wherein the collecting device is configured for two different application situations.

2. The collecting device according to claim 1, wherein the collecting device comprises two collecting portions for respectively one of the different application situations, which are optionally arranged on opposite surfaces of the receiving element.

3. The collecting device according to claim 1, wherein the rim element and the receiving element are non-destructively detachable from each other and/or connectable to each other.

4. The collecting device according to claim 1, wherein the collecting device comprises an additional information and/or a receptacle for an additional information.

5. A collecting device for determining a distribution of agricultural spreading material, comprising a rim element and a receiving element, wherein the rim element comprises a rim portion which at least partially delimits the receiving element on at least one side, and the receiving element comprises a collecting portion for collecting agricultural spreading material, wherein the collecting device is configured for use in tall crops.

6. The collecting device according to claim 5, wherein the collecting device, in particular the rim element and/or the receiving element, comprises one or more installation aids.

7. The collecting device according to claim 6, wherein the installation aids comprise a stand and/or fold-out and/or extendable standing aids.

8. The collecting device according to claim 5, wherein the installation aid comprises an indicator for horizontal alignment of the collecting device.

9. The collecting device according to claim 5, wherein the collecting device has a large contact area at a low weight, in particular a weight per unit area of less than 50 kg/m², in particular less than 10 kg/m².

10. A collecting device for determining a distribution of agricultural spreading material, comprising a rim element and a receiving element, wherein the rim element comprises a rim portion which at least partially delimits the receiving element on at least one side, and the receiving element comprises a collecting portion for collecting agricultural spreading material, wherein the collecting device comprises a means for influencing the light conditions.

11. The collecting device according to claim 10, wherein the collecting device comprises a light.

12. The collecting device according to claim 11, wherein the collecting device comprises a light on at least one side of the collecting device and/or wherein the collecting device comprises a light around a collecting portion of the receiving element.

13. The collecting device according to claim 10, wherein the collecting device is configured to be reflective and/or fluorescent in at least one portion.

14. A collecting device for determining a distribution of agricultural spreading material, comprising a rim element and a receiving element, wherein the rim element comprises a rim portion which at least partially delimits the receiving element on at least one side, and the receiving element comprises a collecting portion for collecting agricultural spreading material, wherein the collecting device comprises two fixedly connected parts made of different materials and/or the rim element and the receiving element are configured as two separate parts.
